(19) United States
(12) Patent Application Publication
(10) Pub. No.: US 2003/0210789 A1
(43) Pub. Date: Nov. 13, 2003

(54) Data transmission links

(75) Inventors: Timothy David Farnham, Bristol (GB); Chan Yeob Yeun, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/345,227

(22) Filed: Jan. 16, 2003

(30) Foreign Application Priority Data
Jan. 17, 2002 (GB) 0201049.4

(51) Int. Cl. H04K 1/00

(52) U.S. Cl. 380/270

(57) ABSTRACT

This invention generally relates to secure communications links for data transmission and more particularly relates to data communications links in which asymmetric cryptographic techniques are used to establish a secure link using symmetric cryptography.

A method of establishing a secure communications link between a mobile terminal of a mobile communications system and a server, the method comprising: retrieving from storage, in the mobile terminal a prime number, p, and generator, g, for a Diffie-Hillman key exchange protocol; generating a positive integer b at the terminal; sending a message including the value of (g^{b}mod p) from the terminal to the server; determining a shared secret number for the terminal and the server by calculating the value of (g^{ab} mod p), where a is a positive integer, at both the terminal and the server, using b and a public value for the server y=g^{a} mod p at the terminal, and using a, b, g and p at the server; and using the shared secret number to establish said secure communications between the terminal and the server. Corresponding software is also provided.

The method facilitates fast and if desired, anonymous, download of software to a mobile communications system terminal.

### FIELD OF THE INVENTION

This invention generally relates to secure communications links for data transmission and more particularly relates to data communications links in which asymmetric cryptographic techniques are used to establish a secure link using symmetric cryptography.

### BACKGROUND OF THE INVENTION

Data transmission is becoming increasingly important within mobile phone networks and, in particular, this is important to so-called 2.5G and 3G (Third Generation) networks as described, for example, in the standards produced by the Third Generation Partnership Project (3GPP, 3GPP2), technical specifications for which can be found at www.3gpp.org, and which are hereby incorporated by reference.

Secure data transmission is important for m-commerce but, in addition to this, the secure download and installation of software onto mobile terminals will also be important for multimedia entertainment, telle-medicine, upgrades for programmable mobile terminals, upgrades to different wireless standards, and the like. Reconfigurable mobile terminals are able to provide increased flexibility for end users who can customise the terminals for their personal needs by downloading and installing the desired applications, for example to support different types of radio systems and to allow the integration of different systems. However techniques are needed to protect mobile terminals against hackers maliciously substituting their software for software available from a handset manufacturer, network operator or trusted third party source.

Broadly speaking at present two basic cryptographic techniques, symmetric and asymmetric, are employed, to provide secure data transmission for example for software download. Symmetric cryptography uses a common secret key for both encryption and decryption, along traditional lines. The data is protected by restricting access to this secret key and by key management techniques, for example, using a different key for each transmission or for a small group of data transmissions. A well-known example of symmetric cryptography is the US Data Encryption Standard (DES) algorithm (FIPS-46, FIPS-47-1, FIPS-74, FIPS-81 of the US National Bureau Standards). A variant of this is triple DES (3DES) in which three keys are used in succession to provide additional security. Other examples of symmetric cryptographic algorithrms are RC4 from RSA Data Security, Inc and the International Data Encryption Algorithm (IDEA).

Asymmetric or so-called public key cryptography uses a pair of keys one “private” and one “public” (although in practice distribution of the public key is also often restricted). A message encrypted with the public key can only be decrypted with the private key, and vice-versa. An individual can thus encrypt data using the private key for decryption by any one with the corresponding public key and, similarly, anyone with the public key can securely send data to the individual by encrypting it with the public key safe in the knowledge that only the private key can be used to decrypt the data.

Asymmetric cryptographic systems are generally used within an infrastructure known as Public Key Infrastructure (PKI) which provides key management functions. Asymmetric cryptography can also be used to digitally sign messages by encrypting either the message or a message digest, using the private key. Providing the recipient has the original message they can compute the same digest and thus authenticate the signature by decrypting the message digest. A message digest is derived from the original message and is generally shorter than the original message making it difficult to compute the original message from the digest; a so-called hash function may be used to generate a message digest.

A Public Key Infrastructure normally includes provision for digital identity Certificates. To prevent an individual posing as somebody else an individual may prove his identity to a certification authority which then issues a certificate signed using the authority's private key and including the public key of the individual. The Certification Authority's public key is widely known and therefore trusted and since the certificate could only have been encrypted using the authority's private key, the public key of the individual is verified by the certificate. Within the context of a mobile phone network a user or the network operator can authenticate their identity by signing a message with their private key; likewise a public key can be used to verify an identity. Further details of PKI for wireless applications can be found in WPKI, WAP-217-WPKI, version 24-April 2001 available at www.wapforum.org and in the X.509 specifications (PKIX) which can be found at www.ietf.org, all hereby incorporated by reference.

In the context of 3G mobile phone systems standards for secure data transmission have yet to be determined and discussions are currently taking place in the MExE forum (Mobile Execution Environment Forum) at www.mexeforum.org. Reference may also be made to ISO/IEC 1170-3, “Information Technology—Security Techniques—Key Management—Part 3: Mechanism Using Asymmetric Techniques”, DIS 1996.

Asymmetric cryptography was first publicly disclosed by Diffie and Hellman in 1976 (W. Diffie and D. E. Heilman, “New directions in cryptography”, IEEE Transactions on Information Theory, 22 (1976), 644-654) and a number of asymmetric cryptographic techniques are now in the public domain of which the best known is the RSA (Rivest, Shamir and Adleman) algorithm (R. L. Rivest, A. Shamir and L. M. Adleman, “A method for obtaining digital signatures and public-key cryptosystems”, Communications of the ACM, 21 (1978), 120-126). Other more recent algorithms including elliptic curve crypto systems (see, for example, X9.63, “Public key cryptography for the financial services industry: Key agreement and key transport using elliptic curve cryptography”, Draft ANSI X9F1, October (1999)). The above-mentioned X.509 ITU (International Telecommunications Union) standard is commonly used for public key certificates. In this a certificate comprising a unique identifier for a key issuer, together with the public key (and normally information about the algorithm and certification authority) is included a directory, that is a public repository of certificates for use by individuals and organisations.

The main aims of a security system are authentication—of the data originator or recipient, access control, non-repudiation—proving the sending or reception of data, integrity of the transmitted data, and confidentiality. Preferably there should be provision for “anonymous” data download, that is the provision or broadcasting of data without specifically identifying a recipient.

The symmetric and asymmetric cryptographic techniques outlined above each have advantages and disadvantages. Asymmetric approaches are less resource-efficient, requiring complex calculations and relatively longer key lengths than symmetric approaches to achieve a corresponding level of security. A symmetric approach, however, requires storage of secret keys within the terminal and does not provide non-repudiation or anonymous software download. The present invention combines both these approaches, broadly speaking using public key techniques to transfer a secret session key. A symmetric session may then be established using this key, for example to download software securely. After software download this key may be stored in a repository in the mobile terminal for non-repudiation purposes or discarded once the software or other data download is complete. This technique supports a hierarchical infrastructure for key management such as X.509 or WPKI, the ability to broadcast to multiple mobile terminals, the ability to anonymously download software to mobile terminals (adopting asymmetric techniques) and faster software download by mobile terminals after establishing a symmetric session (using symmetric techniques).

### SUMMARY OF THE INVENTION

According to a first aspect of the present invention there is therefore provided a method of establishing a secure communications link between a mobile terminal of a mobile communications system and a server, the method comprising, retrieving from storage, in the mobile terminal a prime number, p, and generator, g, for a Diffie-Hillman key exchange protocol; generating a positive integer b at the terminal; sending a message including the value of (g^{b}mod p) from the terminal to the server; determining a shared secret number for the terminal and the server by calculating the value of (g^{ab} mod p), where a is a positive integer, at both the terminal and the server, using b and a public value for the server y=g^{a} mod p at the terminal, and using a, b, g and p at the server; and using the shared secret number to establish said secure communications between the terminal and the server.

The skilled person will recognise that the roles of the mobile terminal and server may be exchanged. The shared secret number may either be used as the session key or may be used to generate a session key, for example by hashing data known to both the terminal and server. The prime number p and generator g may be stored locally, for example, in the mobile terminal SIM (Subscriber Identity Module) card, preferably with the public value y for the server, for example as part of a digital certificate for the server. Alternatively the public value y may be sent from the server to the terminal.

In a preferred embodiment the public value y is encrypted using a public key for the terminal before being sent to the terminal from the server together with, preferably, an identifier for the server. This allows authenticated session key exchange providing protection against so-called man-in-the-middle attacks. To provide additional security a time stamp may be encrypted and sent, or preferably exchanged between the terminal and server to provide for time-related session key validation and expiry. A random number or nonce (number for use only once) may be sent or exchanged additionally or alternatively to the time stamp.

Preferably the value of g^{b}mod p is encrypted using the server's public key before being sent from the terminal to the server, for additional security. In this case the server's public key may be stored within the terminal, for example on the SIM.

The risk of malicious software download may be further reduced by digitally signing the software and accompanying licence or other document. However rather than signing the data in a conventional way the entire code or data to be downloaded may be signed using a signature operation which allows message recovery and then only the signature sent. Alternatively the data or software may be sent en clair and the accompanying licence or other document signed using a signature which allows such message recovery, this latter approach providing much of the benefit of the former without the need to perform a signing operation on the entire data or code portion.

The invention also provides a method of establishing a secure communications link between a server of a mobile communications system and a mobile terminal, the method comprising, retrieving from storage, in the server a prime number, p, and generator, g, for a Diffie-Hillman key exchange protocol, generating a positive integer b less than p−1 at the server, sending a message including the value of (g^{b}mod p) from the server to the terminal, determining a shared secret number for the server and the terminal by calculating the value of (g^{ab} mod p), where a is a positive integer less than p−1, at both the server and the terminal, using b and a value y=g^{a} mod p for the terminal at the server, and using a, b, g and p at the server; and using the shared secret number to establish said secure communications between the server and the terminal.

For convenience the method has been described as it applies to both ends of the communication link. However aspects of the invention provide separately only those steps of the method implemented at the server-end and only those steps implemented at the terminal end of the link.

In other aspects the invention provides computer program code to implement the method at the server-end of the link and computer program code to implement the method at the terminal-end of the link. This code is preferably stored on a carrier such as a hard or floppy disk, CD- or DVD-ROM or on a programmed memory such as a read-only memory or Flash memory, or it may be provided on an optical or electrical signal carrier. The skilled person will appreciate that the invention may be implemented either purely on software or by a combination of software (or firmware) and hardware, or purely in hardware. Likewise the steps of the method as implemented at either end of the link need not be necessarily be performed within a single processing element but could be distributed amongst a plurality of such elements, for example on a network of processors.

Embodiments of the above-described methods remove the necessity of installing a unique symmetric session key in the mobile terminal at manufacture and provide the ability to broadcast to multiple terminals and to provide anonymous software download which is not otherwise achievable with symmetric techniques. The ability to anonymously download software and other data enables secure software and data download for each terminal/client request, thus enabling the downloading of free software, tickets, coupons and excerpts of a streamed media data such as music and MPEG movie clips. The combination of symmetric and asymmetric techniques, and in particular the ability of the methods to operate within an X.509 or WPKI infrastructure, also facilitates m-commerce. Furthemore the procedures are not entirely reliant on asymmetric techniques and allow, the faster symmetric algorithms also to be employed.

The skilled person will recognise that features and aspects of the above invention may be combined where greater security is required.

### BRIEF DESCRIPTION OF THE DRAWINGS

The invention will now be further described, by way of example only, with reference to the accompanying figures in which:

FIG. 1 shows a generic structure for a 3G mobile phone system;

FIG. 2 shows a schematic representation of key management for a secure communications link between a mobile device of a mobile phone network and a server coupled to the network; and

FIG. 3 shows a computer system for implementing a method according to an embodiment of the present invention.

### DETAILED DESCRIPTION

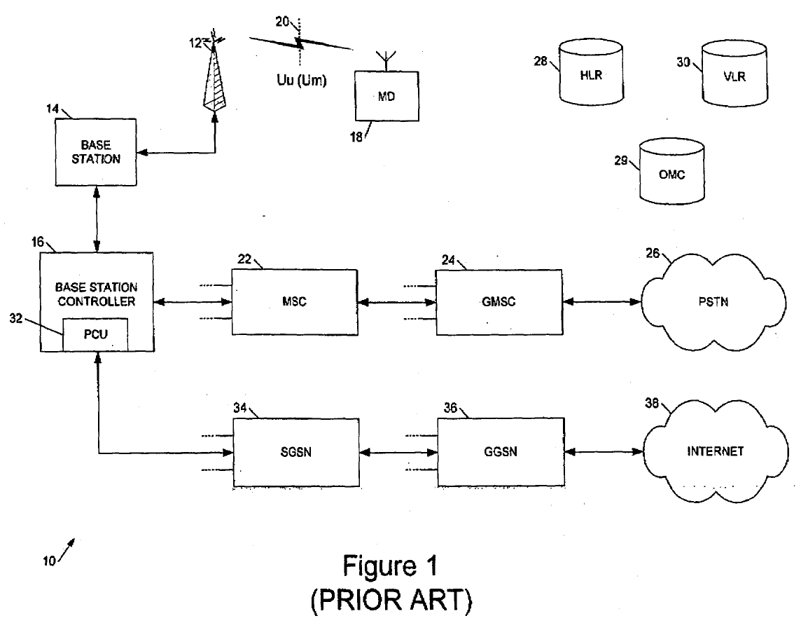

FIG. 1 shows a generic structure of a third generation digital mobile phone system at 10. In FIG. 1 a radio mast 12 is coupled to a base station 14 which in turn is controlled by a base station controller 16. A mobile communications device 18 is shown in two-way communication with base station 14 across a radio or air interface 20, known as a Um interface in GSM (Global Systems for Mobile Communications) networks and GPRS (General Packet Radio Service) networks and a Uu interface in CDMA2000 and W-CDMA networks. Typically at any one time a plurality of mobile devices 18 are attached to a given base station, which includes a plurality of radio transceivers to serve these devices.

Base station controller 16 is coupled, together with a plurality of other base station controllers (not shown) to a mobile switching centre (MSC) 22. A plurality of such MSCs are in turn coupled to a gateway MSC (GMSC) 24 which connects the mobile phone network to the public switched telephone network (PSTN) 26. A home location register (HLR) 28 and a visitor location register (VLR) 30 manage call routing and roaming and other systems (not shown) manage authentication, billing. An operation and maintenance centre (OMC) 29 collects the statistics from network infrastructure elements such as base stations and switches to provide network operators with a high level view of the network's performance. The OMC can be used, for example, to determine how much of the available capacity of the network or parts of the network is being used at different times of day.

The above described network infrastructure essentially manages circuit switched voice connections between a mobile communications device 18 and other mobile devices and/or PSTN 26. So-called 2.5G networks such as GPRS, and 3G networks, add packet data services to the circuit switched voice services. In broad terms a packet control unit (PCU) 32 is added to the base station controller 16 and this is connected to a packet data network such as Internet 38 by means of a hierarchical series of switches. In a GSM-based network these comprise a serving GPRS support node (SGSN) 34 and a gateway GPRS support node (GGSM) 36. It will be appreciated that both in the system of FIG. 1 and in the system described later the functionalities of elements within the network may reside on a single physical node or on separate physical nodes of the system.

Communications between the mobile device 18 and the network infrastructure generally include both data and control signals. The data may comprise digitally encoded voice data or a data modem may be employed to transparently communicate data to and from the mobile device. In a GSM-type network text and other low-bandwidth data may also be sent using the GSM Short Message Service (SMS).

In a 2.5G or 3G network mobile device 18 may provide more than a simple voice connection to another phone. For example mobile device 18 may additionally or alternatively provide access to video and/or multimedia data services, web browsing, email and other data services. Logically mobile device 18 may be considered to comprise a mobile terminal (incorporating a subscriber identity module (SIM) card) with a serial connection to terminal equipment such as a data processor or personal computer. Generally once the mobile device has attached to the network it is “always on” and user data can be transferred transparently between the device and an external data network, for example by means of standard AT commands at the mobile terminal-terminal equipment interface. Where a conventional mobile phone is employed for mobile device 18 a terminal adapter, such as a GSM data card, may be needed.

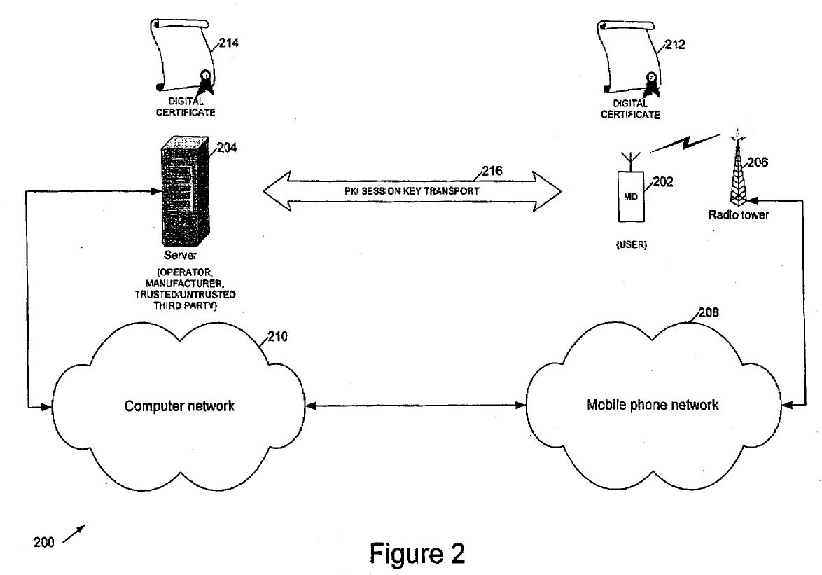

FIG. 2 schematically illustrates a model 200 of a system employing a method according to an embodiment of the present invention. A mobile device 202 is coupled to a mobile communications network 208 via a radio tower 206. The mobile communications network 208 is in turn coupled to a computer network 210, such as the Internet, to which is attached a server 204. One or both of the mobile device 202 and server 204 stores a digital certificate, the digital certificate 212 stored in mobile device 202 including a public key for server 204 and the digital certificate 214 stored in server 204 including a public key for the mobile device 202. (Other embodiments of the invention dispense with one or both these digital certificates).

A PKI session key transport mechanism 216 is provided to transport a session key between the mobile device 202 and the server 204, the PKI transport mechanism employing asymmetric cryptographic techniques using information from one or both of the digital certificates. The session key transported by the PKI mechanism is a secret session key for use with a symmetric cryptographic procedure and, because of the PKI transport, there is no need to store and manage pre-installed unique secret session keys on the server or mobile device.

The PKI transport mechanism 216 may comprise a unilateral transport mechanism from the server to the mobile device or vice-versa or may provide a mutual exchange mechanism for obtaining a shared session key. The server may be operated by a network operator, mobile device manufacturer, or a trusted or untrusted third party; where the server is operated by an untrusted third party, the digital certificates may be dispensed with.

The mobile device is typically controlled by a user of the mobile communications network. For simplicity only a single mobile device is shown although, in general, a session key may be multicast to a plurality of such devices, or even broadcast.

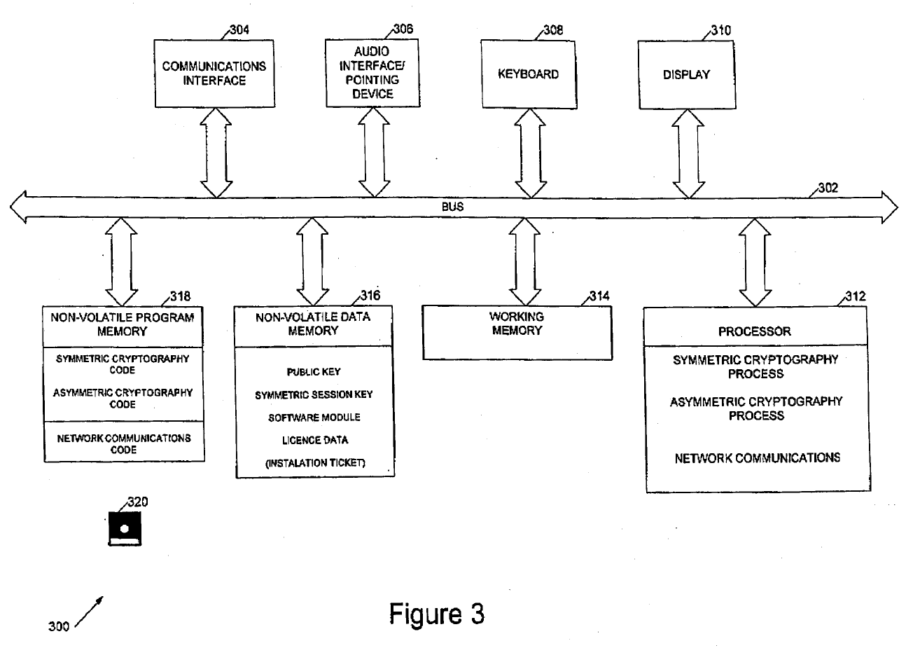

FIG. 3 shows a general purpose computer system 300 for implementing methods, as described below, according to embodiments of the invention. Depending upon whether the computer system is at the server end or the mobile user end of the link the computer system may comprise part of the server 204 of FIG. 2 or part of the mobile device 202 of FIG. 2. Where the computer system comprises part of the mobile device it may be implemented within the device itself or on a separate computer system attached to the device or in some other manner, for example on a SIM card or similar module.

The computer system comprises an address and databus 302 to which is coupled a keyboard 308, display 310 and an audio interface 306 in the case of a mobile phone or a pointing device 306 in the case of a server (unless the implementation is on a SIM card) in which case the phone provides these functions. Also coupled to bus 302 is a communications interface 304 such as a network interface (for a server), a radio interface (for a phone) or a contact pad interface (for a SIM card). Further coupled to bus 302 are a processor 312, working memory 314, non-volatile data memory 316, and non-volatile programme memory 318, the non-volatile memory typically comprising Flash memory.

The non-volatile programme memory 318 stores network communications code for the phone/server's SIM card operating system and symmetric and asymmetric cryptography code. Processor 312 implements this code to provide corresponding symmetric and asymmetric cryptography processes and a network communications process. The non-volatile data memory 316 stores a public key, preferably within a digital certificate, the server storing a public key for one or more mobile users, the mobile device storing public keys for one or more server operators. The non-volatile data memory also stores a symmetric session key, once this has been established, software (either for download from the server or software which is being downloaded onto the mobile device/SIM card) and preferably licence data for the software and, in some instances, one or more installation tickets for controlling use of downloaded software. The software may comprise data such as video or MP3 data or code.

Generally it is desirable that software or data is obtained by a mobile terminal from trustworthy entities or trusted providers such as manufacturers, operators, and service providers that can be relied upon to make correct statements about the validity of software modules. The information that a trusted entity considers a specific core software module to be valid should preferably be made available to the terminal in a secure way.

In a symmetric approach a so-called ticket server issues installation tickets only for valid software modules. It is controlled and operated by a trusted provider. By issuing an installation ticket, the ticket-server represents that the software module which the ticket is referring to is valid. The installation ticket contains a cryptographically-strong, collision-resistant (hard to guess) one-way hash value of the software module which the terminal uses to check the integrity of the downloaded software module. A Message Authentication Code (MAC) (for example a keyed hash function see, for example, Computer data authentication. National Bureau of Standards FIPS Publication 113, 1985) is used to protect the installation ticket. This MAC is computed using a secret key shared by the terminal and the ticket server. By checking a ticket's MAC, the terminal verifies that a trusted provider has issued the ticket and that the ticket has not been modified. Then it checks the integrity of the received software module by comparing the hash values of the received software module and the one contained in the installation ticket. However, this technique does not guarantee non-repudiation in the event of any dispute between the trusted provider and the terminal users, since both shares the secret key so anyone who has the secret key could generate the MAC of a ticket.

An asymmetric signed license approach makes use of public-key cryptography. Similarly to the ticket-based approach, a license contains the information necessary to authenticate the integrity of a software module. A signed license can be a newly defined format, or it can be in previously defined format, such as an X.509 certificate, or a WTLS (Wireless Transport Layer Security) certificate. A license should preferably at least contain the cryptographic hash of the software module and other pertinent information, such as validity dates, the issuer identity, and the recipient identity can also be included. The license is signed by a license server, which is controlled and operated by a trusted provider.

The license server issues licenses only for valid software modules, so by issuing a license for a piece of software, the license server in effect states that this software module is valid. Since a public-key signature scheme is used, every entity that has access to the public-key of the license server can check the signature of a license. Thus, this approach provides non-repudiation if there is any dispute between mobile terminal users and the service provider that will protect the both parties. In other words, only the license server can generate a valid signature for a license since only the license server knows the corresponding private key to sign the license.

Terminals can obtain an installation ticket or a signed license in different ways. They can wait until a software module is received and then directly ask for the ticket or license from the server. Alternatively, a ticket or license may be obtained indirectly through a download server or reconfiguration manager node. In the indirect approach, the software is bundled with the ticket or license and the entire package is sent to the terminal.

The symmetric and asymmetric approaches differ in the requirements they put on the terminal capabilities and on the amount of security data. The signed license approach requires that the terminal perform asymmetric cryptographic operations, which, in general, are more costly in terms of processing power and memory, which are in short supply on a terminal than symmetric cryptographic operations. The ticket-server approach requires only secret-key cryptography, which, in general, requires less processing. However, in the symmetric approach, communication with an online ticket server is always necessary, whereas with the asymmetric approach, it is not necessary for the license server to always be online.

In both cases, the terminal needs to complete the collision-resistant one-way hash value of the loaded software module. In the symmetric approach a ticket's validity is confirmed using a MAC, and in the asymmetric approach, a licence's validity is confirmed by checking a digital signature. A digital signature typically requires more data, so the number of bits in a license will generally be more than in a ticket.

The main objective of both these approaches is to protect terminals against malicious downloaded software. They do not protect against attacks that involve physical modifications of the terminal, such as the replacement of program memory, nor are they are intended to limit the distribution and use of software or to protect a software module against reverse-engineering. The security of the symmetric approach, however, requires that the terminal maintain the secrecy of the cryptographic key that it shares with the ticket server, whereas the asymmetric approach relies on a public-key, i.e. the level of secrecy required to protect the symmetric key is necessary for protecting the public key.

In this described embodiment to integrate the symmetric and asymmetric approaches it is assumed that PKI (Public Key Infrastructure) is employed and trusted parties such as manufacturers and operators issue their certificates to mobile terminals which store them in secure tamper resistance modules such as smart or other cards (for example, a SIM: Subscriber Identity Module, WIM: Wireless Identity Module, SWIM: Combined SIM and WIM, USIM: Universal Subscriber Identity Module).

PKI provides non-repudiation and protects both parties; the symmetric session key provides a low overhead and fast download once it has been transported (using the certified public key) from trusted parties such as manufacturers, operators, etc. This session key may be valid for only a short period for increased security.

This approach provides a unique secret session key so there is no need to install such a key, and no need for permanent secure storage of a key in the mobile terminal which otherwise can limit the key management between the trusted service providers and the terminals and the ability to broadcast to multiple mobile terminals and provide anonymous software download. The anonymous software download techniques for the mobile terminal which will be described enable secure software download for each terminal/client request such as downloading free software, tickets, coupons and the like.

Firstly software download techniques initiated by the operator/server will be described.

The originator A in this example the trusted software provider, (i.e. the terminal manufacturer, network operator, or the like is assumed to possess a priori an authentic copy of the encryption public key of the intended recipient B, the mobile terminal, and the terminal is assumed to have a copy of the server's (public) encrypting key.

One technique for establishing a shared secret session key is then as follows:

M1:A→B:P_{B}(k∥B∥T_{A}∥S_{A}(k∥B∥T_{A}∥LC)) Equation 1

where M1: A→B, denotes that A sends M1 to B, and where k is a secret session key, B is an optional identifier for B (the intended recipient), T_{A} is an optional time stamp that is generated by A, LC is an optional digital licence, for example a software licence and ∥ denotes concatenation of data. Utilising a time stamp hinders replay attacks, but in other embodiments a (preferably random) number may be used in addition to, or in place of, the time stamp, TH, for example generated from a clock. This may be used as a seed for a deterministic pseudo—random number generator so that both A & B can then generate synchronised series of pseudo-random numbers for use as session keys. Such a number (in the message) may be a nonce—a number used only once. P_{B} (Y) denotes public key encryption such as RSA, (R. L. Rivest, A. Shamir and L. M. Adleman, “A method for obtaining digital signatures and public-key cryptosystems”, Communications of the ACM, 21 (1978), 120-126). ECC, (N. Koblitz, “Elliptic curve cryptosystems”, Mathematics of Computation, 48 (1987), 203-209) ElGamal, (T. ElGamal, “A public key cryptosystem and a signature scheme based on discrete logarithms”, IEEE Transactions on Information Theory, 31 (1985), 469-472) of data Y using party B's public key and S_{A} (Y) denotes a signature operation on Y using A's private signature key.

Alternatively, a signature operation which allows recovery of the signed message can be used, such as the RSA signature with message recovery algorithm (ISO/IEC 9796, “Information technology—Security techniques—Digital signature scheme giving message recovery”, International Organization for Standardization, Geneva, Switzerland, 1991) can be used as follows:

M1:A→B:P_{B}(S_{A}(k∥B∥T_{A}∥LC)) Equation 2

where k is a secret session key, B is an optional identifier for B (the intended recipient), T_{A} is an optional time stamp that is generated by A, and LC is an optional digital licence, for example a software licence.

In use, once the terminal obtains a signed session key, for example with a license, the terminal waits for a software module to arrive and, after receiving the software, the terminal is able (i.e. permitted) to execute the software with the session key. Alternatively, an entire software package can be sent to terminal together with a signed session key and license.

A related technique employing an anonymous RSA signature with message recovery can be used for downloading free software and coupons. This can be useful for trusted service providers wishing to broadcast trial versions of software and short clips of music and movies. In such cases it is desirable for anyone to be able intercept messages to obtain a session key. This key may be valid for only a short period for example 30 minutes for a film trailer reducing the need for authentication although it is desirable to provide for identification of the session key issuer, preferably an identification which can be easily verified. Thus the session key may be digitally signed by the manufacturer/operator or the service provider. One embodiment of this technique is therefore as follows:

M1:A→B:S_{A}(k∥B∥T_{A}∥LC) Equation 3

where k is a secret session key, B is an optional identifier for B (the intended recipient), T_{A} is an optional time stamp that is generated by A, and LC is an optional digital licence, for example a software licence.

In this embodiment an RSA signature operation with message recovery scheme is used (for example, ISO/IEC 9796:1991). Since the message is signed by A there is no need to include an identifier for A; including an identifier for the recipient allows the recipient to confirm they are the intended recipient. The terminals receiving M1 each have an appropriate certificate for A, the originator/operator to allow the message to be extracted from S_{A}, for example, stored on SIM. This can also be used for broadcasting a session key to allow free software download, and enables terminals to download software anonymously.

In a variant of this technique, the key k is replaced by a Diffie-Hellman public value gⁿ mod p (see, for example, W. Diffie and D. E. Hellman, ibid), where n is a positive integer satisfying 1≦n≦p−2. An alternative to M1 is then as follows:

M1:A→B:S_{A}(gⁿmod p∥B∥T_{A}∥LC) Equation 4

where k is a secret session key, B is an optional identifier for B (the intended recipient), T_{A} is an optional time stamp that is generated by A, and LC is an optional digital licence, for example a software licence.

The mobile terminal B or the client can obtain the server's public value Y_{A}=g^{a} mod p that is contained in the server key exchange or the SIM may contain the server's public value. The originator (in this example, the server A) chooses a random value n, computes gⁿ mod p and sends M1 including gⁿ mod p to the terminal. The server A can then compute a session key k=Y_{A}ⁿ=(g^{a})ⁿ=g^{an} mod p and the terminal B can compute the same session key using k=(gⁿ)^{a}=g^{na} mod p.

Encrypted software may then be sent to the terminal B by encrypting the software with the common session key. An eavesdropper does not know the private key of server (that is a) and thus, it is computationally infeasible to determine the session key. This method can be used for distributing system software to mobile equipment for anonymous secure software download, for example for broadcasting a SIM update, because an individual recipient need not be specified.

In the above four scenarios, upon decrypting M1, recipient B will use a session key to download software from the originator/operator A. After software download, B may put the session key in the repository or may discard the session key which depends on the key management between the trusted service providers and the terminals.

In the above scenarios, upon decrypting M1, the recipient B can use the session key to download software from the originator/operator A. After the software download, B may put the session key in the repository or may discard the key, which is chosen depending on, among other things, the key management between the trusted service providers and the terminals. For an operating system upgrade a non-anonymous, rather than an anonymous technique is preferred as it is useful to know to whom the upgrade has been sent.

Next software download techniques initiated by the mobile terminal will be described; these are close to mirror images of the above server-initiated techniques. We will describe a secure software download and anonymous software download techniques based on asymmetric techniques such as RSA and Diffie-Hellman, for initiating key changes from the mobile terminal. These techniques can be used for establishing a symmetric session key for secure implementation of each individual request for a data item or group of items, such as software, tickets, coupons, and the like.

In the technique signed bocks are encrypted by combining a digital signature and public key encryption as follows:

M1:B→A:P_{A}(k∥A∥T_{B}∥S_{B}(k∥A∥T_{B}∥LC)) Equation 5

where k is a secret session key, A is an optional identifier for A (the intended recipient), T_{B} is an optional time stamp generated by B, and LC is an optional digital licence, for example a software licence.

The terminal, B, generates a session key and signs a combination of the session key, A's identity and a time stamp. This session key, signature and, optionally the time stamp and A's identifier, are encrypted with the server's certified public key extracted, for example, from a prior server key exchange message. Software, such as video clips and music, is sent from the server A to the client B using the session key. Since an eavesdropper does not know the server's private key, it is computationally infeasible for him/her to compromise the session key k, particularly since this may be only valid for one session or a limited period.

As previously described an anonymous crytographic technique such as anonymous RSA can also be described, as follows:

M1:B→A:P_{A}(k∥A∥T_{B}∥LC) Equation 6

where k is a secret session key, A is an optional identifier for A (the intended recipient), T_{B} is an optional time stamp generated by B, and LC is an optional digital licence, for example a software licence.

The terminal, B generates a session key K and encrypts it with the server's certified public key (extracted from a server key exchange message). The software may then be sent to the client B using the session key K. Since an eavesdropper does not know the server's private key, it is computationally infeasible for the one time session key k to be compromised.

Alternatively, an anonymous Diffie-Heliman cryptographic technique can be employed as follows (a mobile-initiated technique is described; the server-initiated technique corresponds):

First an appropriate prime p and generator g of Z*ₚ are selected and published, and, for example, stored on the terminal SIM. Here Z*ₚ is the multiplicative group 1,2,3 . . . . p−1 and (2≦g≦p−2). One way to generate an appropriate p and g is described in RFC (Request For Comments) 2631.

M1:B→A:g^{b}mod p Equation 7

The mobile terminal B or client can obtain the server's public value Y_{A}g^{a} mod p where is the private key of the server, for example from a server key exchange. Preferably, however the server's public value is stored in the SIM. The terminal chooses a random value b, computes g^{b} mod p and sends M1 g^{b} mod p (encrypted) to the server. Both a and b are positive integers satisfying 1≦a≦p−2 and 1≦b≦p−2. The mobile terminal B can compute a key for a symmetric session

k=Y_{A}^{b} mod p=(g^{a} mod p)^{b} mod p=g^{ab} mod p and the server A can compute the same session key k=(g^{b} mod p)^{a} mod p=g^{ba} mod p. Encrypted data or software may then be sent to the terminal B by encrypting it with a session key or the session key may be used by both the terminal and server to generate another common key, for example by operating on data known to both with K. An eavesdropper does not know the private key of server (a) and it is thus computationally infeasible to determine the session key. Anonymous RSA and Diffie-Hellman can be used, for example for downloading free software, tickets and coupons.

Anonymous software download techniques generally only provide protection against passive eavesdroppers. An active eavesdropper or active man-in-the-middle attack may replace the finished message with their own during the handshaking process for creating sessions. In order to avoid this attack server authentication is desired.

Analogously to the anonymous RSA signature technique with message recovery described above with reference to Equation 4, the Diffie-Hellman value g^{b} modp may be encrypted using the originator's (that is, in this example, B's) private key. More specifically it may be protected by sending the Diffie-Hellman value as a digital signature from which the signed message is recoverable. The recipient may then recover g^{b} modp using the originator's public key, more specifically by extracting the message from the signature.

Under certain circumstances, the Diffie-Hellman and (DH) the related Elliptic Curve Diffie-Hellman (ECDH) key agreement schemes (X9.63, “Public key cryptography for the financial services industry: Key agreement and key transport using elliptic curve cryptography”, Draft ANSI X9F1, October (1999)) are susceptible to a class of attacks known as “small-subgroup” attacks. Where, if a key belongs to a small subgroup a directed brute-force attack based on guessing keys from the subgroup may succeed. In the anonymous DH and ECDH cases there is a risk that such a small subgroup attack will lead communicating parties to share a session key which is known to an attacker. This threat can be alleviated by using a predetermined group determined “good” or “strong” values of g and p and checking that received public keys do not lie in a small subgroup of the group, or by not re-using ordinary DH key pairs. Background information on protection against these attack, can be found in the draft ANSI standards X.9.42 (X.9.42, “Agreement of symmetric keys using Diffie-Hellman and MQV algorithms”, ANSI draft, May (1999)) and. X.9.63 (X9.63, “Public key cryptography for the financial services industry: Key agreement and key transport using elliptic curve cryptography”, Draft ANSI X9F1, October (1999)).

Mutual key authentication protocols will now be described. In these both A and B are authenticated by exchanging messages having information or a property characteristic of A and B, in the protocols below messages encrypted using the public keys of A and B.

In a first mutual authentication process A, B possess each other's authentic public key or, each party has a certificate carrying its own public key, and one additional message is sent by each party for certificate transport to the other party. Background information on this protocol can be found in Needham and Schroeder (R. M. Needham and M. D. Schroeder, “Using encryption for authentication in large networks of computers”, Communications of the ACM, 21 (1978), 993-999).

The messages sent are as follows:

M1:A→B:P_{B}(k₁∥A∥T_{A}) Equation 8

M2:A←B:P_{A}(k₁∥k₂) Equation 9

M3:A→B:P_{B}(k₂) Equation 10

The steps of the procedure are as follows:

1. The originator operator (or server) A sends M1, including a first key k₁, to B.

2. The receiver user (terminal) B recovers k₁ upon receiving M1, and returns M2, including a second key k₂, to A.

3. Upon decrypting M2, A checks that the key k₁ recovered from M2 agrees with that sent in M1. A then sends B M3.

4. Upon decrypting M3, B checks the key k₂ recovered from M3 agrees with that sent in M2. The session key may be computed as f (k₁∥k₂) using an appropriate publicly known non-reversible function f such as MD5 (Message Digest 5, as defined in RFC 1321) and SHA-1 (secure Hash Algorithm-1, see, for example, US National Bureau of Standards Federal Information Processing Standards (FIPS) Publication 180-1.

5. B then starts downloading software by using the symmetric session key f (k₁∥k₂). After software download, B may discard the session key or keep it for a short period, depending on the key management strategy.

A second X509 mutual authentication process operates in the context of the X.509 strong two-way authentication procedure (ISO/IEC 9594-8, “Information technology Open systems interconnection—The directory: Authentication framework”, International Organisation for Standardization, Geneva, Switzerland 1995) is described as follows:

Let D_{A}=(T_{A}∥R_{A}∥B∥P_{B}(k₁)), D_{B}=(T_{B}∥R_{B}∥A∥P_{A}(k₂)). Equation 11

Where A and B comprise identifiers for the server and terminal respectively.

M1:A→B:Cert_{A}∥D_{A}∥S_{A}(D_{A}) Equation 12

M2:A←B: Cert_{B}∥D_{B}∥S_{B}(D_{B}) Equation 13

Where the Cert_{A} and Cert_{B} are public certificates for A & B respectively. The steps of the procedure are as follows:

1. A obtains a timestamp TA indicating an expiry time, then generates a random number R_{A}, obtains a symmetric key k₁, encrypts K₁, using P_{B} and sends a message M1 to B. (Since the message is signed by A there is no need to include an identifier for A; including an identifier for the recipient in D_{A} allows the recipient to confirm they are the intended recipient).

2. B verifies the authenticity of Cert_{A}, extracts A's signature public key, and verifies A's signature on the data block D_{A}. B then checks that the identifier in M1 specifies itself as intended recipient and that the timestamp T_{A} is valid, and checks that R_{A} has not been replayed.

3. If all checks succeed, B declares the authentication of A successful, decrypts k₁ using its a session key, and saves this now shared key for downloading software securely. (This terminates the protocol if only unilateral authentication is desired.). B then obtains a timestamp T_{B}, generates random number R_{B}, and sends A a message M2.

4. Similarly A carries out actions analogous to those carried out by B. If all checks succeed, A declares the authentication of B successful, and key k₂ is available for subsequent use. A and B share mutual secrets k₁ and k₂ so the session key may be computed as f (k₁∥k₂) which may then be used for downloading software securely (here “software” is used in a general sense to mean soft data).

An authenticated Diffie-Hellman session key exchange can be achieved by using public key encryption as follows:

The originator A (that is the trusted software provider, terminal manufacturer, operator or the like) and a mobile terminal B possess an authentic copy of the encryption public key of A and B this may be, for example, locally stored or the public keys may be exchanged between the parties, for example, as digital certificates. As with anonymous Diffie-Hellman described above an appropriate prime p and generator g of Z*ₚ (2≦g≦p−2) are selected and published and, preferably, stored locally in the terminal messages are then exchanged as follows:

M1:A→B:P_{B}(g^{a}mod p ∥A∥T_{A}) Equation 14

M2:A←B:P_{A}(g^{b} mod p∥B∥T_{A}∥T_{B}) Equation 15

M3:A→B:S_{A}(Eₖ(software∥LC)) Equation 16

Where A & P_{A} and B and P_{B} comprise identifiers and public keys of the originator and terminal respectively and T_{A} and T_{B} are time stamps for messages from A & B respectively (A, B, T_{A} and T_{B} are optional) k denotes an encryption operation performed using key k.

A chooses a random value a, computes g^{a} mod p and sends M1 to B (there is no need to store g^{a} mod p in the terminal and because this value is encrypted it is safe from main-in-the-middle attacks). The mobile terminal B decrypts the received message using its private key and chooses a random value b, computes g^{b} mod p and sends M2 (g^{b} mod p) to A which decrypts the message using its private key. Both a and b are positive integers satisfying 1≦a≦p−2 and 1≦b≦p−2. The terminal B then computes a session key k=(g^{a} mod p)^{b} mod p=g^{ab} mod p; the originator A can also compute the session key using k=(g^{b} mod p)^{a} mod p=g^{ba} mod p. A then signs the encrypted software and LC preferably using the shared session key k and sends it to B; here LC is a software licence, optionally specifying a validity period of the session key k, giving copyright details and the like. An eavesdropper does not know the private keys of A and B and commitment values a and b, and thus, it is computationally infeasible to determine the session key and the threat from man in the middle attacks is alleviated. The encrypted identifiers A and B provide a guarantee of the sender's identity for the messages, thus preferably M1 includes A although there is less need for M2 to include B. Similarly only B knows T_{A} so including this in M2 (whether or not T_{B} is also included) allows A to imply that the message was correctly received by B. Including T_{B} permits a time window T_{B}-T_{A} to be defined; this is preferably shorter than any likely decrypt time, for example less than one hour. Here, preferably T_{A} defines a sending time for M1 and T_{B} a receive time (at B) for M1.

In variants of the method alternatives to M3 are as follows:

i) M3:A→BEₖ(software∥LC)

ii) M3:A→BEₖ(software∥LC)S_{A}(Eₖ(software∥LC))

iii) M3:A→BEₖ(software)S_{A}(LC)

These alternatives can provide faster encryption. In (ii) a signature operation without operation message recovery can be used; in (iii) only the licence is signed, preferably with message recovery, unless the licence is within the software (optionally in (iii) an encrypted version of the licence Eₖ(LC) may be signed).

Timestamps may be used to provide freshness and (message) and can provide a time window for uniqueness guarantees, message reply. This helps provide security against known-key attacks is required, vulnerable to replay attacks of the unilateral key authentication protocols. The security of timestamp-based techniques relies on use of a common time reference. This in turn requires that synchronised host clocks be available and clock drift and must be acceptable given the acceptable time window used. In practice synchronisation to better than 1 minute is preferred although synchronisation to better than 1 hour may be acceptable with longer time windows. Synchronisation can be achieved by, for example, setting an internal clock for the terminal on manufacture.

Where the terminal possesses an authentic certificate for A, the originator or operator, (either locally stored or received in a message) then the above unilateral key authentication techniques provide secure software download. For mutual authentication protocols where both A and B possess authentic certificates or public keys there are no known attacks which will succeed, apart from brute force attacks to recover the private keys of A and B. However in an X.509—context procedure, because there is no inclusion of an identifier such as A within the scope of the encryption P_{B} within D_{A}, one cannot guarantee that the signing party actually knows the plaintext key. That is, because the identity is not encrypted the message could be signed by someone who had not encrypted the key.

The uses of public key technology to transport a symmetric session key for secure software download has been described. This combines the advantages of both the asymmetric and symmetric approaches. PKI provides with non-repudiation and protects both parties if there is a dispute, but PKI is computationally intensive and would be inefficient for secure software download on its own. A symmetric session key provides a means to enable efficient and fast download once the key has been transported using a certified public key issued by trusted parties. The lifetime of the session key can be short (for example for a single data transfer) or long (for example, months) depending on the security requirements and likelihood of the key being compromised.

The described techniques are also suitable for the MExE standard for future programmable mobile user equipment. Moreover, the anonymous software download techniques enable secure software download for each terminal/client request for downloading free software, tickets, coupons, as well as for secure M-Commerce.

Embodiments of the invention have been described in the context of a server and mobile terminal of a mobile communications system but aspect of the invention also have other applications, for example in networked computer systems. It will also be recognised, in general, either the terminal or the server may comprise the initial message originator in the above protocols although for conciseness the specific exemplary embodiments are described with reference to one or other of these as the orginator. The invention is not limited to the described embodiments but encompasses modifications apparent to those skilled in the art within the spirit and scope of the claims.

We claim:

1. A method of establishing a secure communications link between a mobile terminal of a mobile communications system and a server, the method comprising:
retrieving from storage, in the mobile terminal a prime number, p, and generator, g, for a Diffie-Hellman key exchange protocol;
generating a positive integer b less than p−1 at the terminal;
sending a message including the value of (g^{b}mod p) from the terminal to the server;
determining a shared secret number for the terminal and the server by calculating the value of (g^{ab} mod p), where a is a positive integer less than p−1, at both the terminal and the server, using b and a value y=g^{a} mod p for the server at the terminal, and using a, b, g and p at the server; and
using the shared secret number to establish said secure communications between the terminal and the server.

2. A method as claimed in claim 1 further comprising retrieving from storage in the mobile terminal the public value y.

3. A method as claimed in claim 1 further comprising:
encrypting the public value y at the server end of the communications link using a public key for the terminal, the public key being a key of an asymmetric cryptographic technique, to provide a first encrypted message;
sending the first encrypted message to the terminal; and
decrypting the public value y from the first encrypted message at the terminal.

4. A method as claimed in claim 3 wherein said encrypting further comprising encrypting an identifier for the server, whereby said first encrypted message includes said server identifier; wherein said decrypting further comprises decrypting said server identifier; and wherein the method further comprising checking said server identifier at the terminal.

5. A method as claimed in claim 3 wherein said encrypting further comprises encrypting a server-end time stamp, whereby said first encrypted message includes said server-end time stamp; wherein said decrypting comprises decrypting said server-end time stamp for validating said secure communications link.

6. A method as claimed in claim 4 wherein said encrypting further comprises encrypting a server-end time stamp, whereby said first encrypted message includes said server-end time stamp; wherein said decrypting comprises decrypting said server-end time stamp for validating said secure communications link.

7. A method according to claim 1 further comprising:
encrypting the value of (g^{b} mod p) at the terminal using a public key for the server, the public key being a key of an asymmetric cryptographic technique, to provide a second encrypted message;
sending the second encrypted message to the server; and
decrypting the value of (g^{b} mod p) from the second encrypted message at the server.

8. A method according to claim 7 wherein said encrypting further comprises encrypting an identifier for the terminal, whereby said second encrypted message includes said terminal identifier; wherein said decrypting further comprises decrypting said terminal identifier; and wherein the method further comprising checking said terminal identifier at the server.

9. A method according to claim 7 wherein said encrypting further comprises encrypting a terminal-end time stamp, whereby said second encrypted message includes said terminal-end time stamp; wherein said decrypting further comprises decrypting said terminal-end time stamp for validating said secure communications link.

10. A method according to claim 8 wherein said encrypting further comprises encrypting a terminal-end time stamp, whereby said second encrypted message includes said terminal-end time stamp; wherein said decrypting further comprises decrypting said terminal-end time stamp for validating said secure communications link.

11. A method according to claim 5 further comprising:
encrypting the value of (g^{b} mod p) at the terminal using a public key for the server, the public key being a key of an asymmetric cryptographic technique, to provide a second encrypted message;
sending the second encrypted message to the server; and
decrypting the value of (g^{b} mod p) from the second encrypted message at the server and wherein
said encrypting further comprises encrypting a terminal-end time stamp, whereby said second encrypted message includes said terminal-end time stamp,
said decrypting further comprises decrypting said terminal-end time stamp for validating said secure communications link, and
said second encrypted message includes said server-end time stamp.

12. A method according to claim 1 further comprising:
sending a message digitally signed by the server from the server to the terminal.

13. A method according to claim 12 wherein the digital signature provides for message recovery, and wherein the message which is digitally signed comprises at least a licence identifier.

14. A method according to claim 12 wherein the message digitally signed by the server includes data encrypted using said shared secret number.

15. A method according to claim 13 wherein the message digitally signed by the server includes data encrypted using said shared secret number.

16. A method of securely communicating data comprising establishing a secure communications link by the method of claim 1 and securely communicating data over the link.

17. A method as claimed in claim 1 wherein the message including the value of (g^{b} mod p) comprises a digital signature from which the value of (g^{b} mod p) is recoverable.

18. A method of establishing a secure communications link between a server of a mobile communications system and a mobile terminal, the method comprising:
retrieving from storage, in the server a prime number, p, and generator, g, for a Diffie-Hellman key exchange protocol;
generating a positive integer b less than p−1 at the server;
sending a message including the value of (g^{b}mod p) from the server to the terminal;
determining a shared secret number for the server and the terminal by calculating the value of (g^{ab} mod p), where a is a positive integer less than p−1, at both the server and the terminal, using b and a value y=g^{a} mod p for the terminal at the server, and using a, b, g and p at the server; and
using the shared secret number to establish said secure communications between the server and the terminal.

19. A method as claimed in claim 18 wherein the message including the value of (g^{b} mod p) comprises a digital signature from which the value of (g^{b} mod p) is recoverable.

20. A data transmission link configured to implement the method of claim 1 or 18.

21. A carrier carrying computer program code for a terminal to implement the part of the method of claim 1 performed at the terminal end of the communications link.

22. A mobile terminal including the carrier of claim 21.

23. A carrier carrying computer program code for a terminal to implement the part of the method of claim 18 performed at the terminal end of the communications link.

24. A mobile terminal including the carrier of claim 23.

25. A carrier carrying computer program code for a server to implement the part of the method claim 1 performed at the server end of the communications link.

26. A server including the carrier of claim 25.

27. A carrier carrying computer program code for a server to implement the part of the method claim 18 performed at the server end of the communications link.

28. A server including the carrier of claim 27.
